(19) United States
(12) Patent Application Publication
(10) Pub. No.: US 2017/0357991 A1
(43) Pub. Date: Dec. 14, 2017

(54) COMPUTER-IMPLEMENTED CUSTOMER-ADVERTISER MUTUAL BENEFIT SYSTEM AND METHOD

(71) Applicant: Kyle Grone, Phoenix, AZ (US)

(72) Inventor: Kyle Grone, Phoenix, AZ (US)

(21) Appl. No.: 15/177,281

(22) Filed: Jun. 8, 2016

(51) Int. Cl. G06Q 30/02; G06Q 20/10

(52) U.S. Cl. CPC G06Q 30/0209; G06Q 30/0251; G06Q 30/0203; G06Q 20/1085

(57) ABSTRACT

Disclosed is a computer-implemented customer-advertiser mutual benefit system disposed in operative communication with a computer-based financial transaction processing system, which, among other things, electronically processes a monetary amount from a customer. The user interfaces of the benefit and the transaction systems being seamlessly provided by a common user terminal. The benefit system comprises a tasks module for delivering a task to the customer prior to receiving the monetary amount and a points module for, upon the completion of a task, rewarding the customer one or more points, each of which having a monetary value. A part of or the entirety of the monetary value earned by the customer is deducted from the monetary amount.

### BACKGROUND

The present invention relates to novel computer-implemented systems and methods aimed at improving the attention span of customers towards promotional content and more particularly, to a computer-implemented customer-advertiser mutual benefit system and method that incentivizes customers in exchange for the consumption of promotional content published by an advertiser.

Given the sheer magnitude of business competition translating into rampant usage of all forms of media for relentless advertising, today, the attention span of consumers is at an all time low. Within these minute attention spans, creating a brand recall in the minds of customers is quite a challenge for the advertisers. Even though advertisers may come up with high quality promotional content, it is only a matter of time before a competitor one-ups with even a better one. Secondly, no matter how superior a promotional content is, the prospect of increasing the attention span for that particular brand (or promotional content endorsing the brand) is impossible as attention span is dictated by the overall cut-throat competitive culture of present day businesses.

There's a need in the art to come up with novel ways of advertising a product that grabs consumers' attention for a relatively long while so as to create brand recall within the thus improved attention span.

### SUMMARY

An embodiment of the present invention comprises a computer-implemented customer-advertiser mutual benefit system that enables a customer to monetarily benefit from the consumption of promotional content published by the advertiser. In other words, the benefit system incentivizes the customers in exchange for the consumption of promotional content. The benefit system is disposed in operative communication with a financial transaction processing system, which, among other things, is configured to electronically process a monetary amount from the customer in exchange for a rendered service or services. The user interfaces of benefit system and the transaction system are configured to be seamless and are provided by a common user terminal over a communications network. More particularly, the user terminal may comprise an automated-teller machine (ATM), a vending machine, or a smart device, such as a smartphone, tablet PC, laptop, etc. The benefit system is, upon the customer's consent, configured to be deployed prior to the customer completing his/her transaction with the transaction system.

The benefit system comprises a tasks module for delivering an advertiser task to the customer upon recognizing that a customer is about to pay for the aforementioned outstanding monetary amount. A task basically involves consumption of promotional content, which may comprise completing an online customer survey, watching a promotional video, completing a promotional video game, etc. Notably, each task is associated with a predetermined number of points, each of which carrying a monetary value. Upon the completion of the task, the corresponding points are rewarded to the customer wherein, the monetary value of the earned points is deducted from the outstanding monetary amount before being finally processed by the transaction system.

Other features and advantages will become apparent from the following description of the preferred embodiments, taken in conjunction with the accompanying drawings.

### BRIEF DESCRIPTION OF THE DRAWINGS

Various embodiments of the disclosed system and method are described herein with reference to the accompanying drawings, which form a part of this disclosure, wherein:

FIG. 1, according to an embodiment of the present disclosure, is a schematic block diagram of the computer-implemented mutual benefit system.

FIG. 2, according to an embodiment of the present disclosure, is a flowchart depicting the computer-implemented mutual benefit method.

The various aspects of the present disclosure mentioned above are described in further detail with reference to the aforementioned figures and the following detailed description of exemplary embodiments.

### FIGURES—REFERENCE NUMERALS

10—Computer-implemented Mutual Benefit System
12—Tasks Module
14—Tasks Database
16—User Interface
18—Points Module
20—Points Database
22—Balance Module
24—Deduction Module
26—Communications Network
28—Smartphone
30—ATM
32—Vending Machine

### DETAILED DESCRIPTION

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

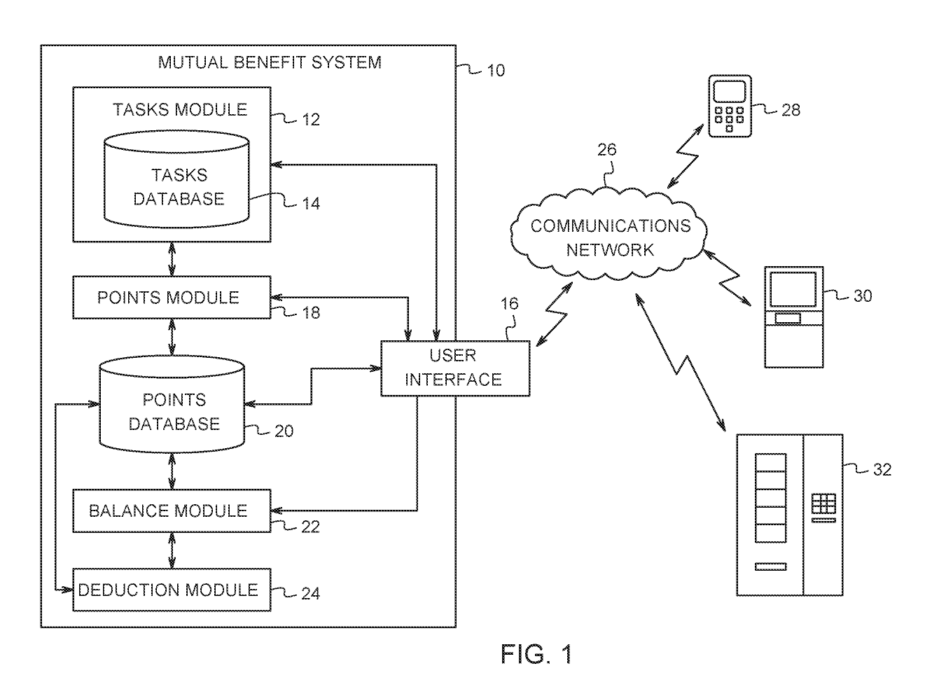

Referring to FIG. 1, an embodiment of the present invention comprises a computer-implemented customer-advertiser mutual benefit system 10 that enables a customer to monetarily benefit from the consumption of promotional content published by the advertiser. The benefit system 10 is disposed in operative communication with a financial transaction processing system (not shown), which, among other things, is configured to electronically process a monetary amount from the customer in exchange for a rendered service or services. The user interfaces of benefit system 10 and the transaction system are configured to be seamless and are provided by a common user terminal over a communications network 26. More particularly, the user terminal may comprise an automated-teller machine (ATM) 30, a vending machine 32, or a smart device, such as a smartphone 28, tablet PC, laptop, etc. The benefit system 10 is, upon the customer's consent, configured to be deployed prior to the customer completing his/her transaction with the transaction system.

Referring to FIG. 1, the benefit system 10 comprises a tasks module 12, which in turn comprises a tasks database 14 and a prompt module (not shown). The tasks database 14 comprises a plurality of advertiser tasks listed therein wherein, each task is associated with a predetermined number of points. Notably, each point carries a monetary value. A task basically involves consumption of the aforementioned promotional content, which may comprise completing an online customer survey, watching a promotional video, completing a promotional video game, etc. Upon the completion of the task, the corresponding points are duly rewarded to the customer. The prompt module, upon recognizing that a customer is about to pay for the aforementioned monetary amount, prompts the customer to participate in one or more advertiser tasks—one task at a time—in exchange for earning points. In the event of the customer not consenting, the monetary amount is processed by the transaction system.

Referring to FIG. 1, however, if the customer consents, the tasks module 12 delivers a task to the customer from the tasks database 14. Upon the completion of the task, the user is rewarded the corresponding number of points, the monetary value of which is deducted from the outstanding monetary amount before being finally processed by the transaction system. In the event of the user terminal being a vending machine 32, the monetary value is deducted from cost incurred by the customer for the purchased product. Similarly, in the event of the user terminal being a smart device 28 and the customer is about to purchase a product from an online market place, the monetary value is deducted from cost incurred by the customer for the purchased product or services. On the other hand, in the event of the user terminal being an ATM 30, the monetary value is deducted from the processing fee, which is to be paid by customer for availing one of the services of the ATM 30. For example, the monetary value may be deducted from the standard 2% fee that is charged by an ATM for withdrawal of cash.

Referring to FIG. 1, in one embodiment, the benefit system 10 recognizes each customer when he/she is registered therewith whereby, the points earned by the customer are accrued in his/her account. More particularly, in this embodiment, in order for a customer avail this opportunity (of points accrual), a customer has to be registered therewith. The customer may register by the widely-practiced way of filling out a registration form and having his/her phone number or email address verified by sending a registration link to the email or a verification pin to his/her phone. Alternatively, in order to register, a customer, upon selecting an exemplary “registration button” provided by the user interface 16, is supplied with a unique registration code to his/her phone. The unique code is then inputted back into the user terminal whereby, the phone number and thereby the customer is instantly identified. In one embodiment, instead of the registration code, a QR code is supplied to the customer's phone. For the phone (and thereby the customer) to be recognized, the supplied QR code is scanned by the user terminal and upon match, the customer is instantly identified.

Referring to FIG. 1, the benefit system 10 further comprises a points module 18 and a points database 20, which is disposed in operative communication with the points module 18. The points database 20 is listed with a plurality of customer entries therein wherein, each customer entry represents a registered customer. Each listed customer is associated with at least one points entry wherein, a points entry comprises the number of points earned by the customer at a given time. Notably, each points entry is time-stamped. Further, each points entry is associated with a monetary value, which is equivalent to the monetary value of the corresponding number of points. Upon the customer being rewarded the points, the points module 18 timestamps and lists the earned points within the points database 20. The benefit system 10 further comprises a balance module 22 that calculates and displays the total number of points earned by the customer till date and the total monetary value thereof. The benefit module 22 further comprises a deduction module 24 comprising an input field for enabling the customer to input the monetary value he/she wishes to be deducted from the outstanding monetary amount. Upon input, the deduction module 24 deducts said value from the monetary amount whereafter, the remaining monetary amount is processed by the transaction system. More particularly, the monetary amount is received from the customer's credit or debit cards. Upon the completion of the transaction, the points database is updated accordingly.

Another embodiment of the present invention comprises a computer-implemented customer-advertiser mutual benefit method that enables a customer to monetarily benefit from the consumption of promotional content published by the advertiser. The benefit method involves the operation of a financial transaction processing system, which, among other things, is configured to electronically process a monetary amount from the customer in exchange for a rendered service or services.

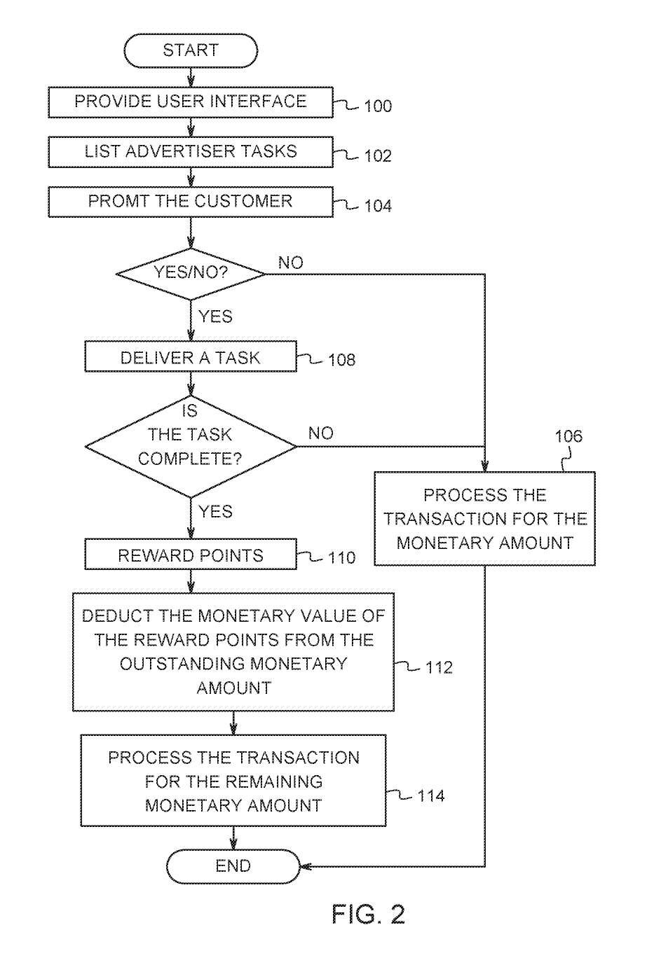

Referring to FIG. 2, the benefit method initiates with providing a user interface (step 100), which is seamlessly associated with that of the transaction system. Both the user interfaces are provided by a common user terminal over a communications network such as, the Internet. More particularly, the user terminal may comprise an automated-teller machine (ATM), a vending machine, or a smart device, such as a smartphone, tablet PC, laptop, etc. The method further comprises listing (step 102) a plurality of advertiser tasks within a tasks database wherein, each task is associated with a predetermined number of points. Notably, each point carries a monetary value. A task basically involves consumption of the aforementioned promotional content, which may comprise completing an online customer survey, watching a promotional video, completing a promotional video game, etc.

Referring to FIG. 2, the method further comprises prompting (step 104), upon recognizing that a customer is about to pay for the aforementioned monetary amount, the customer to participate in one or more advertiser tasks—one task at a time—in exchange for earning points. In the event of the customer not consenting, the method involves having the transaction system process (step 106) the monetary amount. However, in the event of the customer consenting to the prompt, the method involves delivering (step 108) a task to the customer from the tasks database. In the event of the task not completed by the customer, the method involves having the transaction system to process (step 106) the monetary amount. However, in the event of the customer completing the task, the method involves rewarding (step 110) the customer the corresponding number of points pre-associated with the task.

Referring to FIG. 2, the method further involves deducting (step 112) the monetary value equivalent to the earned points from the outstanding monetary amount. Finally, the method involves having the transaction system to process (step 114) the remaining monetary amount. In the event of the user terminal being a vending machine, the monetary value is deducted from cost incurred by the customer for the purchased product. Similarly, in the event of the user terminal being a smart device and the customer is about to purchase a product from an online market place, the monetary value is deducted from cost incurred by the customer for the purchased product or services. On the other hand, in the event of the user terminal being an ATM, the monetary value is deducted from the processing fee, which is to be paid by customer for availing one of the services of the ATM. For example, the monetary value may be deducted from the standard 2% fee that is charged by an ATM for withdrawal of cash.

In one embodiment, the method involves registering the customer by various means. The customer may register by the widely-practiced way of filling out a registration form and having his/her phone number or email address verified by sending a registration link to the email or a verification pin to his/her phone. Alternatively, in order to register, a customer, upon selecting an exemplary “registration button” provided by the user interface, is supplied with a unique registration code to his/her phone. The unique code is then inputted back into the user terminal whereby, the phone number and thereby the customer is instantly identified. In one embodiment, instead of the registration code, a QR code is supplied to the customer's phone. For the phone (and thereby the customer) to be recognized, the supplied QR code is scanned by the user terminal and upon match, the customer is instantly identified.

The method further involves listing a plurality of customer entries within a points database wherein, each customer entry represents a registered customer. Each listed registered customer is associated with at least one points entry wherein, a points entry comprises the number of points earned by the customer at a given time. Notably, each points entry is time-stamped. Further, each points entry is associated with a monetary value, which is equivalent to the monetary value of the corresponding number of points.

Upon the customer completing the task, the method involves making an entry of the earned points within the points database. More particularly, the earned points are time-stamped before being associated with the corresponding customer entry. The method further involves displaying the total number of points earned by the customer till date and the total monetary value thereof. The method further involves receiving a monetary value input from the customer wherein, the monetary value is less than or equivalent to the total monetary value. The method involves deducting the inputted monetary value from the outstanding monetary amount. Finally, the method involves having the transaction system to process (step 114, FIG. 2) the remaining monetary amount. Upon the completion of the transaction, the points database is updated accordingly.

The aforementioned embodiments are able to be implemented, for example, using a machine-readable medium or article which is able to store an instruction or a set of instructions that, if executed by a machine, cause the machine to perform a method and/or operations described herein. Such machine is able to include, for example, any suitable processing platform, computing platform, computing device, processing device, electronic device, electronic system, computing system, processing system, computer, processor, or the like, and is able to be implemented using any suitable combination of hardware and/or software. The machine-readable medium or article is able to include, for example, any suitable type of memory unit, memory device, memory article, memory medium, storage device, storage article, storage medium and/or storage unit; for example, memory, removable or non-removable media, erasable or non-erasable media, writeable or re-writeable media, digital or analog media, hard disk drive, floppy disk, Compact Disk Read Only Memory (CD-ROM), Compact Disk Recordable (CD-R), Compact Disk Re-Writeable (CD-RW), optical disk, magnetic media, various types of Digital Versatile Disks (DVDs), a tape, a cassette, or the like. The instructions is able to include any suitable type of code, for example, source code, compiled code, interpreted code, executable code, static code, dynamic code, or the like, and is able to be implemented using any suitable high-level, low-level, object-oriented, visual, compiled and/or interpreted programming language, e.g., C, C++, Java, BASIC, Pascal, Fortran, Cobol, assembly language, machine code, or the like. Functions, operations, components and/or features described herein with reference to one or more embodiments, is able to be combined with, or is able to be utilized in combination with, one or more other functions, operations, components and/or features described herein with reference to one or more other embodiments, or vice versa.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A computer-implemented customer-advertiser mutual benefit system disposed in operative communication with a computer-based financial transaction processing system, which electronically processes a monetary amount from a customer, the user interfaces of the benefit and the transaction systems being seamlessly provided by a common user terminal, the benefit system comprising:
(a) a tasks module for, upon consent, delivering to the customer, prior to the processing of a financial transaction, at least one task; and
(b) a points module for, upon the completion of a task, rewarding the customer one or more points, each of which having a monetary value;
wherein, the benefit system is configured such that, a part of or the entirety of the monetary value of the points earned by the customer is deducted from the monetary amount.

2. The benefit system of claim 1 wherein, a task is delivered to the customer upon consent thereof.

3. The benefit system of claim 1 wherein, the at least one task is delivered one task at a time.

4. The benefit system of claim 1 wherein, the user terminal comprises a vending machine.

5. The benefit system of claim 4 wherein, the cost comprises the price of the product purchased from the vending machine.

6. The benefit system of claim 4 wherein, the transaction system comprises a payment gateway.

7. The benefit system of claim 1 wherein, the user terminal comprises an Automated-Teller Machine (ATM).

8. The benefit system of claim 6 wherein, the cost comprises the transaction fee associated with the transaction at the ATM.

9. The benefit system of claim 1 further comprising:
(a) a points database disposed in operative communication with the points module, the points database listed with a plurality of customer entries, each of which representing a customer, each customer entry associated with at least one points entry, each of which comprising the number of points earned by the customer, each of the at least one points entry being time-stamped, each of the at least one points entry associated with a monetary value, which is equivalent to the corresponding number of points;
(b) a balance module for displaying the total monetary value of the points accrued by a customer; and
(c) a deduction module comprising an input field for receiving the an amount, which is less than or equivalent to the total monetary value, the inputted amount deducted from the monetary amount.

10. The benefit system of claim 1 wherein, the task comprises watching a video; the points pre-associated with the video rewarded to the customer upon the completion of the video watch.

11. The benefit system of claim 1 wherein, the task comprises participating in a customer survey; the points pre-associated with the customer survey rewarded to the customer upon the completion of the video watch.

12. The benefit system of claim 1 wherein, the task comprises playing a video game; the points pre-associated with the video game rewarded to the customer upon the completion of the video game.

13. A computer-implemented customer-advertiser mutual benefit method involving the operation of a computer-based financial transaction processing system, which, among other things, electronically processes a monetary amount from a customer, the benefit method comprising:
(a) providing a user interface, which is seamlessly associated with that of the transaction system; both the user interfaces sharing a common user terminal;
(b) delivering to the delivering to the customer, prior to the processing of a financial transaction, at least one task;
(c) rewarding, upon the completion of a task, the customer one or more points, each of which having a monetary value; and
(d) deducting a part of or the entirety of the monetary value of the points earned by the customer from the monetary amount.

14. The benefit method of claim 13 comprising delivering the task to the customer upon consent thereof.

15. The benefit method of claim 13 comprising delivering the at least one task one task at a time.

16. The benefit method of claim 13 wherein, the user terminal comprises a vending machine.

17. The benefit method of claim 16 wherein, the cost comprises the price of the product purchased from the vending machine.

18. The benefit method of claim 16 wherein, the transaction system comprises a payment gateway.

19. The benefit method of claim 13 wherein, the user terminal comprises an Automated-Teller Machine (ATM).

20. The benefit method of claim 19 wherein, the cost comprises the transaction fee associated with the transaction at the ATM.

21. The benefit method of claim 13 further comprising:
(a) listing a plurality of customer entries within a points database, each customer entry representing a customer, each customer entry associated with at least one points entry, each of which comprising the number of points earned by the customer, each of the at least one points entry being time-stamped, each of the at least one points entry associated with a monetary value, which is equivalent to the corresponding number of points;
(b) displaying the total monetary value of the points earned by a customer; and
(c) inputting an amount within an input field, the amount less than or equivalent to the total monetary value; and
(d) deducting the inputted amount from the monetary amount.

22. The benefit method of claim 13 wherein, the task comprises watching a video; the points pre-associated with the video rewarded to the customer upon the completion of the video watch.

23. The benefit method of claim 13 wherein, the task comprises participating in a customer survey; the points pre-associated with the customer survey rewarded to the customer upon the completion of the video watch.

24. The benefit method of claim 13 wherein, the task comprises playing a video game; the points pre-associated with the video game rewarded to the customer upon the completion of the video game.
